(19) United States
(12) Patent Application Publication
(10) Pub. No.: US 2005/0259150 A1
(43) Pub. Date: Nov. 24, 2005

(54) Air-floating image display apparatus

(76) Inventors: Yoshiyuki Furumi, Shiojiri (JP); Makoto Furusawa, Toyoshina (JP)

Correspondence Address: HARNESS, DICKEY & PIERCE, P.L.C., P.O. BOX 828, BLOOMFIELD HILLS, MI, 48303, US

(21) Appl. No.: 11/130,548

(22) Filed: May 17, 2005

(30) Foreign Application Priority Data
May 24, 2004 (JP) 2004-152759

(51) Int. Cl. H04N 7/18

(52) U.S. Cl. 348/144; 348/143

(57) ABSTRACT

To provide an image display apparatus capable of displaying images on arbitrary places while freely moving in the air. Furthermore, to allow images including a predetermined length of data to come into sight of a moving person or persons, in as natural a state as possible. The present image display apparatus includes a flying object capable of moving in the air, a projector mounted on the flying object and projecting images onto the ground (including the soil surface, floors, and walls) below the flying object, and a camera provided on the flying object and photographing places below the flying object. This image display apparatus projects and displays images from the projector on the vicinity of the person or persons recognized by analyzing images photographed by the camera.

### BACKGROUND OF THE INVENTION

1. Field of the Invention

The present invention relates to techniques for projecting and displaying images (including both moving images and still images) from a flying object capable of freely moving in the air, on the lower side such as the ground.

2. Description of the Related Art

Hitherto, there are known advertisement apparatuses and amusement apparatuses that display images on the surfaces of balloons or the like by projecting images from inside the balloons or the like existing on the ground or in the air, onto the surfaces thereof (see Patent Document 1 or 2 for example).
[Patent Document 1] Japanese Unexamined Patent Application Publication No. 5-294288
[Patent Document 2] Japanese Unexamined Patent Application Publication No. 8-314401

### SUMMARY OF THE INVENTION

Conventional apparatuses of this type, however, have not been adapted to display images from the balloons or the like to arbitrary places on the ground. Therefore, the images have not been seen by persons unless the persons intentionally have looked at the balloons or the like. Also, the image displays by the conventional apparatuses have not been easily visible to moving viewers. In addition, conventionally, in the case where images are associated with sounds, the sounds have sometimes spread to surrounding persons other than target persons, thereby causing inconvenience to the surrounding persons.

The present invention has been made to solve the above-described problems. An object of the present invention is to provide an image display apparatus capable of displaying images in arbitrary places while freely moving in the air. Another object of the present invention is to allow images having a predetermined data length to come into sight of even moving person or persons, in as natural a state as possible. Still another object of the present invention is to produce sounds corresponding to projected images only in the vicinity of a targeted person or persons for projection viewing so as not to affect persons around the targeted person(s) for projection viewing.

An air-floating image display apparatus according to the present invention includes a flying object capable of moving in the air, and a projector mounted on the flying object and projecting an image onto the ground (including the soil surface, floors, and walls) below the flying object. This allows the projection of an image to be performed from an arbitrary direction onto an arbitrary place.

The flying object includes a camera for photographing a place below the flying object, and an image is projected from the projector onto the vicinity of the person or persons recognized based on a photographed image by the camera. This allows an image to be displayed with respect to an arbitrary person or persons recognized by the flying object. Besides, since the image is projected onto the vicinity of the recognized person or persons, it is possible to cause the person(s) to direct great attention to the image.

The flying object further includes wings, a wing drive unit for changing the orientation of the wings, a propeller, a propeller drive unit for rotating the propeller, a plurality of obstacle detecting sensors for detecting an obstacle to the flight of the flying object. Herein, the flight of the flying object is controlled by the wings, the wing drive unit, the propeller, the propeller drive unit, and information from the obstacle detecting sensors. This enables the flying object to move in the air while avoiding an obstacle.

The projector projects an image onto the front of the recognized person or persons. This allows the image to be naturally brought into view of the person or persons.

Also, the flying object moves in response to a movement of the recognized person or persons. This enables images with a given data length to be shown to the person(s), in their entity.

Furthermore, the flying object includes a speaker having a directivity by which sound is produced only in the vicinity of the recognized person or persons. This makes it possible to restrain the diffusion range of sound corresponding to the projected image, thereby reducing influence of noise to a low range.

The focus of the projector is adjusted in accordance with a projection distance of the projector. Thereby, clear images are projected and displayed even if the flight altitude varies.

Moreover, the shape of a projected screen by the projector is corrected so as to have a predetermined aspect ratio, based on the shape of the projected screen by the projector, the shape having being recognized from the photographed image by the camera. This enables a high-quality image without deflection to be displayed.

### BRIEF DESCRIPTION OF THE DRAWINGS

FIG. 1 is a schematic view of an embodiment of the present invention.

FIG. 2 is a block diagram of an air-floating image display apparatus according to the embodiment of the present invention.

FIG. 3 is a flowchart showing an example of flight operation of a flying object.

FIG. 4 is a flowchart showing an example of collision avoidance operation of the airship.

FIG. 5 is a flowchart showing an example of operation of an image processing section.

FIG. 6 is a flowchart showing an example of control operation of a projection control section.

### DESCRIPTION OF THE PREFERRED EMBODIMENTS

### First Embodiment

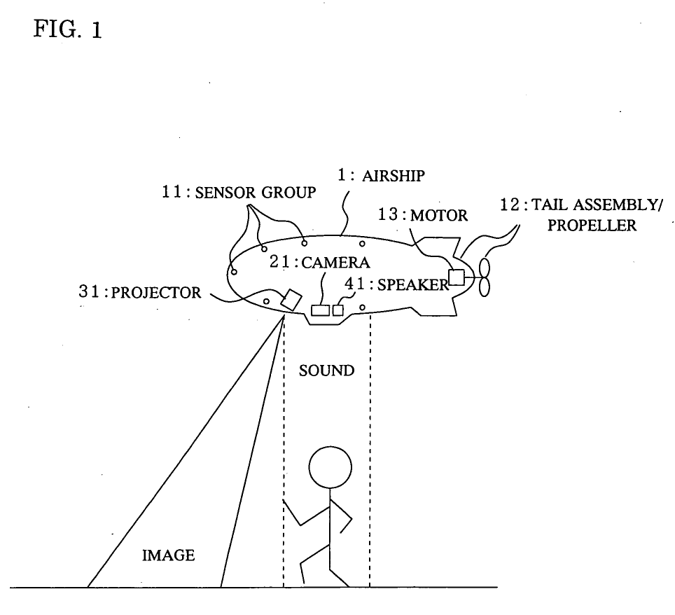

FIG. 1 is a schematic view of a first embodiment of the present invention. An airship (flying object) 1 floating in the air while freely moving in an automatic manner, is indispensable to the present invention. The airship 1 according to this embodiment, therefore, includes tail assembly/propeller 12; tail assembly motor/propeller motor 13, serving as units for driving the tail assembly/propeller 12; and an infrared sensor group 11, serving as sensors for detecting an obstacle to the flight. The airship 1 is equipped with a projector 31, and projects and displays images from the projector 31 on the lower side such as the ground. It is desirable for the projection and display to be associated with a sound output from a speaker 41. On the occasion of the projection and display from the projector 31, it is desirable to photograph places below the airship 1 by a camera 21 mounted on the airship 1, and after having performed the recognition of the photographed images, perform projection and display on the vicinity, especially on the front, of the person or persons recognized by the images, who are treated as a target person or persons. Here, the altitude of the airship 1 is one enough for the projector 31 to display images on target places, and varies depending on the type of the projector 31. For example, 3 m to 4 m gives a measure of the altitude to be used. Floating areas of the airship 1 are not limited to outdoor, but may include interspaces among buildings. Places onto which images are to be projected from the projector 31 are not restricted to the ground, floors, and the like, but may include upright walls.

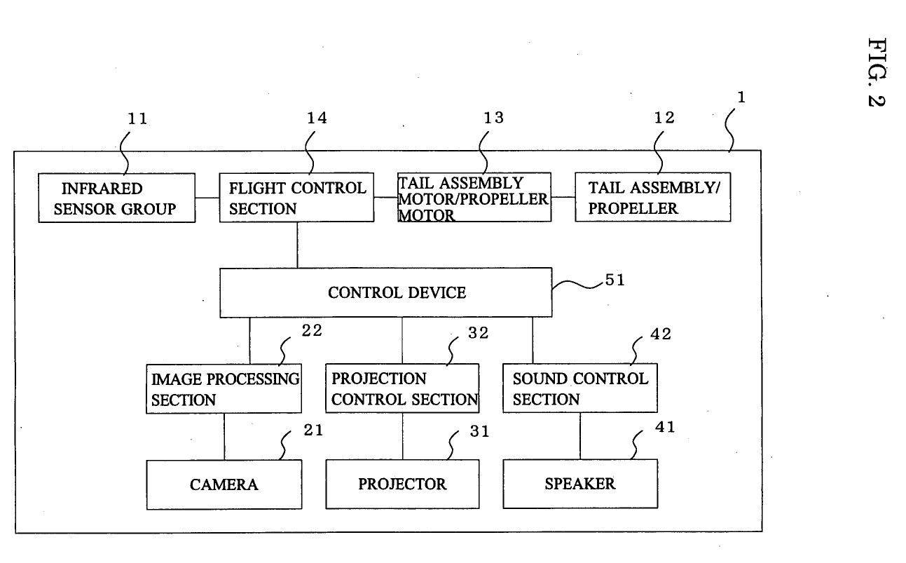

FIG. 2 is a block diagram of a flying object 1, which serves as an air-floating image display apparatus according to the embodiment of the present invention. The airship 1 includes, as components relating to the flight, an infrared sensor group 11, serving as sensors for detecting an obstacle to the flight; tail assembly/propeller (tail assembly and a propeller) 12; tail assembly motor/propeller motor (a tail assembly motor and a propeller motor) 13, serving as units for driving the tail assembly/propeller 12; and a flight control section 14 for operating the above-described components to control the flight of the airship 1. Also, the airship 1 further includes a camera 21 for photographing places below the airship 1; and an image processing section 22 for analyzing photographed images by the camera 21, and recognizing targeted person or persons for projection viewing, the shape of a projected screen, and the like. Furthermore, the airship 1 includes a projector 31 for projecting and displaying images recorded in advance, on places below the airship 1; and a projection control section 32 for controlling the projection of the projector 31. Moreover, the airship 1 includes a speaker 41 for outputting sounds operatively associated with projecting operation of the projector 31; and a sound control section 42 for controlling the output of the speaker 41. A control device 51 further controls all of the above-described control sections 14, 22, 32, and 42, thereby integrally controlling the entire airship 1.

The infrared sensor group 11 is a generic name for a plurality of sensors mounted around the airship 1, for detecting the distance to an obstacle obstructing the flight of the airship 1, taking the advantage of infrared radiation. The infrared sensor group 11 keeps operating during flight, and data detected thereby is captured by the flight control section 14 to be utilized for flight control.

The tail assembly/propeller 12 are directly related to the flight of the airship 1. The tail assembly adjusts the attitude and the moving direction of the airship 1, and the propeller generates a moving force with respect to airship 1. Here, the tail assembly/propeller 12 are driven by the tail assembly motor/propeller motor 13, respectively.

The flight control section 14 comprises a computer and a motor drive circuit, and drivingly controls the tail assembly motor/propeller motor 13 in a direct manner to control the operations of the tail assembly/propeller 12. The flight control section 14 also receives information from the infrared sensor group 11. Upon detecting that the airship 1 is approaching an obstacle, the flight control section 14 determines the moving direction of the airship 1 so as to avoid collision with the obstacle, and based on the determination, it operates the tail assembly motor/propeller motor 13 to actuate the tail assembly/propeller 12.

The camera 21 is mounted on the underside of the airship 1, and continuously photographs places below the airship 1 during flight. Photographed images by the camera 21 are sent to the image processing section 22 comprising a display device and the computer, and the recognition of a person or persons below the airship 1 and the recognition of the shape of projected screens by the projector 31 are performed in the image processing section 22. The person recognition includes the presence or absence of one or more persons below the airship 1, the orientations and movements of the persons. Here, the movements of the persons include states of staying at the same places and of being moving. When the persons are moving, the directions and speeds of the movements are also recognized.

The projector 31 projects and displays images such as an advertisement recorded in advance, on the vicinity, and preferably on the front, of the person recognized through the camera 21, below the airship 1. The projection control section 32 is for operating the projector 31 to properly adjust the focus of a projected screen, based on a projection distance of the projector 31, and correct the projected screen so as to have a predetermined aspect ratio (horizontal to vertical ratio), based on information from the image processing section 22. The projection control section 32, therefore, comprises a computer previously having data for making a proper focus adjustment and aspect correction, based on the actual situations. Here, the ON/OFF control of projection and display by the projector 31 may be relegated to the projection control section 32. Also, the period of time during which the projector 31 performs projection and display may be determined as appropriate. For example, the projection and display may be performed either at all times during flight, or only when a person or persons are recognized.

The speaker 41 is for outputting sounds associated with images by the projector 31, to targeted person or persons for projection viewing. The volume of the sounds and the ON/OFF of the output of the sounds are controlled by the sound control section 42. Here, the speaker 41 is not always indispensable. However, when the speaker 41 is provided, it is preferable that a speaker has a strong directivity by which sounds are produced only in the vicinity of specified person or persons. The speaker 41 may also be one integrated with the projector 31.

The control device 51 is for integrally controlling the functions of the airship 1 by correlating all control sections 14, 22, 32, and 42 with one another, and may comprise a central processing unit (CPU). The following are examples of operations of the control device 51.

When no person is recognized by the image processing section 22, the control device 51 instructs the flight control section 14 to move the airship 1 to another position.

When a person or persons are recognized by the image processing section 22, the control device 51 instructs the flight control section 14 to move the airship 1 so that a projected screen from the projector 31 comes to a predetermined place with respect to the person or persons, and preferably, on the front of the person(s), after having calculated the required moving direction and moving distance. In conjunction with this, the control device 51 instructs the flight control section 14 to fly the airship 1 in response to the moving speed and moving direction of the person(s).

After having projected a series of predetermined images with respect to the current targeted person or persons for projection viewing, the control device 51 instructs the flight control section 14 to move the airship 1 for searching for another person.

The control device 51 can also operate the projection control section 32 and the sound control section 42 in response to a recognition result in the image processing section 22. For example, the control device 51 controls the projection control section 32 and the sound control section 42 to perform projection/display and a sound output only for as long as a person or persons are recognized.

Furthermore, the control device 51 acquires information on a projection distance of the projector 31 utilizing any sensor of the infrared sensor group 11, and instructs the projection control section 32 to properly adjust the focus of the projector 31 in accordance with the acquired projection distance. Also, based on the shape of the projected screen recognized by the image processing section 22, the control device 51 instructs the projection control section 32 to correct the aspect ratio of the projected screen so as to be a predetermined value.

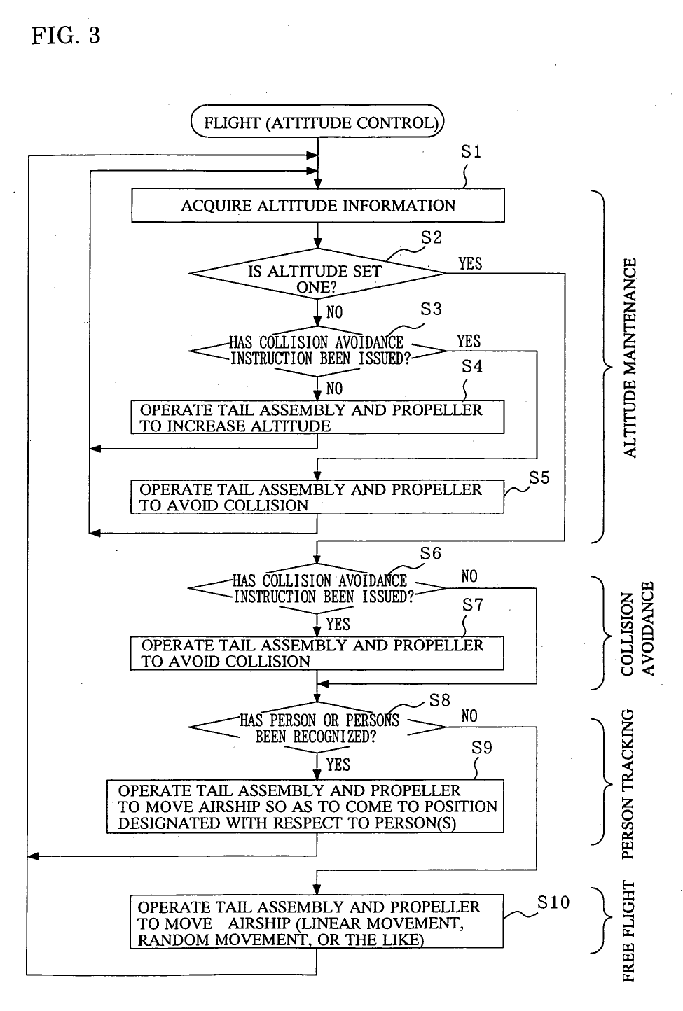

FIG. 3 is a flowchart showing an example of flight operation of the airship 1. This flight operation is one that starts from the state where the airship 1 is launched into the air at an altitude lower than a set altitude.

The airship 1 launched into the air detects the distance from the ground, namely, the altitude, by utilizing any sensor of the infrared sensor group 11. The flight control section 14 takes in the altitude (S1), and determines whether the airship 1 has reached the predetermined altitude (S2). If the airship 1 has not reached the set altitude, the flight control section 14 operates the tail assembly/propeller 12 to increase the altitude (S2 to S4). In this case, if any sensors of the infrared sensor group 11 detect an obstacle at a predetermined distance, the flight control section 14 operates the tail assembly/propeller 12 to avoid an collision therewith (S3 and S5).

If the flight control section 14 determines that the airship 1 has risen up to the set value of altitude (S2), at this altitude position, it again determines by utilizing data of the infrared sensor group 11 whether an obstacle avoidance operation is necessary If it is necessary, the flight control section 14 operates the tail assembly/propeller 12 to avoid a collision (S6 and S7).

On the other hand, if the flight control section 14 determines in step S6 that no obstacle avoidance operation is necessary, or if the processing of step S7 has been completed, it determines whether a person or persons have been recognized, based on the person recognition proceeding performed in the image processing section 22 (S8). If a person or persons have been recognized in the image processing section 22, the flight control section 14 operates the tail assembly/propeller 12 to move the airship 1 so that projected images from the projector 31 come to the front of the person or persons, based on information on the orientation, moving direction, and moving speed of the person(s), obtained in the image processing section 22. Also, if the person or persons are moving, the flight control section 14 moves the airship 1 in response to the moving state of the person(s) (S9). On the other hand, if no person is recognized in step 8, the flight control section 14 operates the tail assembly/propeller 12 to move the airship 1 to an arbitrary position in a linear movement, random movement, or the like (S10). Thereafter, the process returns to the first step S1.

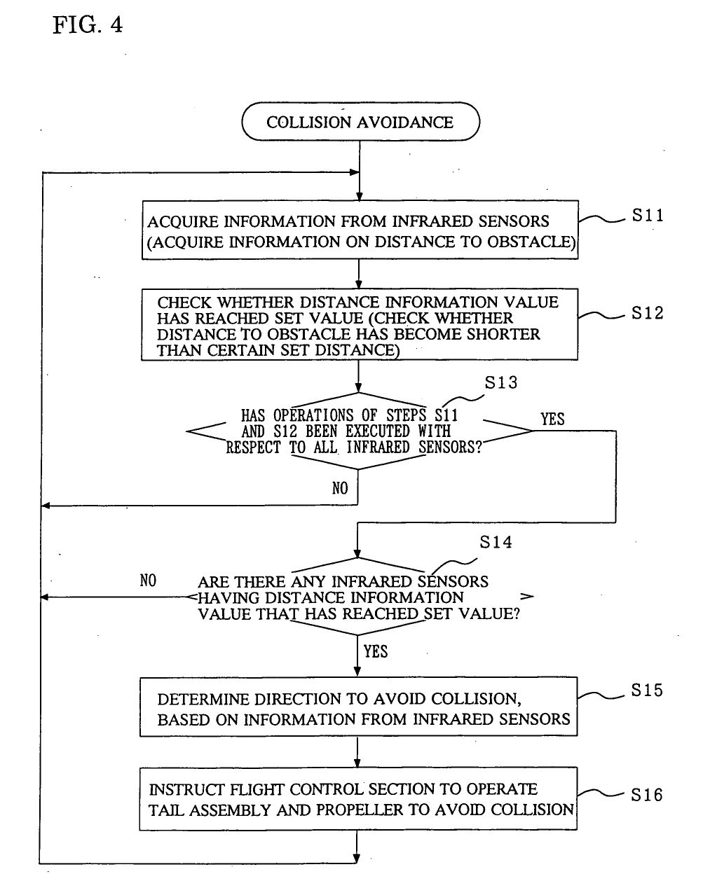

FIG. 4 is a flowchart showing an example of collision avoidance operation of the airship 1, which was referred to in the above description of the flight operation of the airship 1. Based on FIG. 4, the collision avoidance operation of the airship 1 will now be explained.

First, the flight control section 14 acquires, from each of the sensors of the infrared sensor group 11, information on an obstacle, that is, information on the distance from the airship 1 to the obstacle (S11). Next, the flight control section 14 checks whether the value of distance information from each of the sensors has reached a predetermined value, that is, whether the distance to the obstacle has become shorter than a certain set distance (S12). These steps S11 and S12 are performed until they are executed with respect to all sensors of the infrared sensor group 11 (S13). Then, the flight control section 14 checks whether there are any distance information values that have reached the predetermined set value in the distance information values of all sensors of the infrared sensor group 11 (S14). If so, the flight control section 14 determines a moving direction for the airship 1 to avoid a collision, based on the distance information and position information of the corresponding sensors (S15). Then, the flight control section 14 operates the tail assembly/propeller 12 to move the airship 1 in the determined direction, thereby avoiding a collision (S16). On the other hand, if, in step 14, there is no sensor's distance information value that has reached the predetermined set value, the process returns to the first step (S14 to S11).

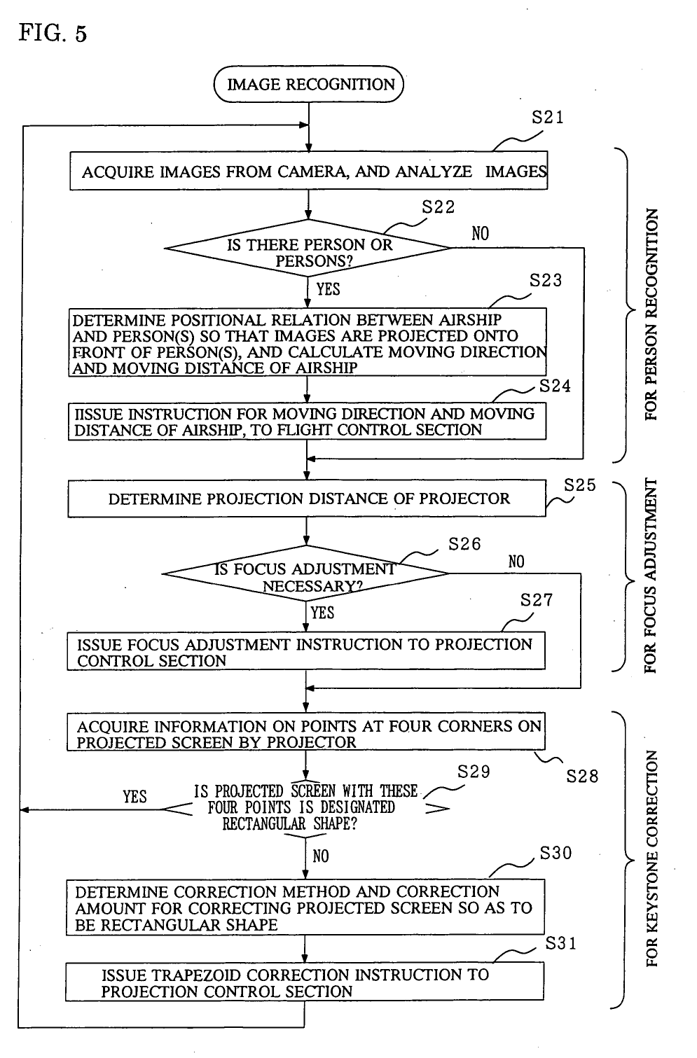

FIG. 5 is a flowchart showing an example of operation of the image processing section 22. The image processing section 22 firstly acquires images photographed by the camera 21 (S21), and after having analyzed the images, it determines whether there is a person or persons below the airship 1 (S22). If a person or persons are recognized, the image processing section 22 determines the positional relation between the airship 1 and the person(s) so that images from the projector 31 are projected onto the front of the person(s), and calculates a direction in which the airship 1 to move and a distance by which the airship 1 to move (S23). Then, the image processing section 22 instructs the flight control section 14 to move the airship 1 in accordance with the above-described direction and distance (S24).

On the other hand, if no person is recognized in step S22, or if the processing of step S24 has been completed, the image processing section 22 determines a projection distance from the size of a projected screen by the projector 31, or by sensors or the like (S25). Then, based on the projection distance, the image processing section 22 determines whether the projector 31 requires a focus adjustment (S26). If the image processing section 22 determines in step S26 that a focus adjustment for the projector 31 is necessary, it instructs the projection control section 32 to make a focus adjustment corresponding to the above-described projection distance (S27). Meanwhile, if no person is recognized in step S22, the process may return to the first step S21.

If the image processing section 22 determines in step S26 that a focus adjustment for the projector 31 is unnecessary, or if the processing of step S27 has been-completed, the image processing section 22 analyzes the images acquired in step S21, and acquires information on the points at four corners of the projected screen by the projector 31 (S28). Then, based on these four points, the image processing section 22 determines whether the projected screen by the projector 31 has a predetermined aspect ratio (S29). Here, the projected screen has a rectangular shape having an aspect ratio of, for example, 4:3 or 16:9. If the projected screen has a trapezoidal shape or the like, which is not a predetermined shape, the image processing section 22 determines a correction method and a correction amount for correcting the projected screen so as to be a predetermined shape (S30), and based on the correction method and the correction amount, the image processing section 22 issues a correction instruction (keystone correction instruction) to correct the above-described projected screen so as to be a predetermined shape, to the projection control section 32 (S31).

If the image processing section 22 determines in step S29 that the above-described projected screen has a rectangular shape with a substantially proper aspect ratio, or if the proceeding of step S31 has been completed, the process returns to the first step S21 (steps S29 to S21, and steps S31 to S21).

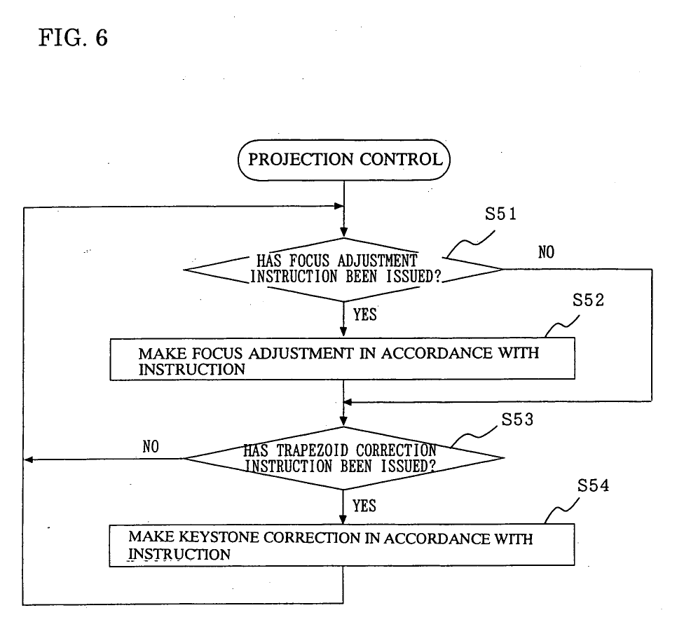

FIG. 6 is a flowchart showing an example of projection control by the projection control section 32, which was referred to in the above description of the image processing section 22. It is here assumed that the projector 31 performs image projection at all times during flight, and that sounds are outputted operatively associated with the image projection.

The projection control section 32 firstly determines the presence or absence of a focus adjustment instruction (S51). If the projection control section 32 has received the focus adjustment instruction, it makes a focus adjustment to the projector 31 in accordance with the instruction (S52). On the bother hand, if no focus adjustment instruction has been issued in step S51, or if the proceeding of the step S52 has been completed, the projection control section 32 now determines the presence or absence of a keystone correction instruction (S53). Here, if the projection control section 32 has received the keystone correction instruction including a correction method and correction amount, it makes a keystone correction to the projected screen by the projector 31 in accordance with the instruction (S54). If no keystone correction instruction has been issued in step S53, or if the proceeding of the step S54 has been completed, the processing by the projection control section 32 returns to step S51 (S53 to S51, and S54 to S51).

According to the moving air-floating image display apparatus in accordance with the present embodiment, it is possible to freely set projection display places at arbitrary places. This allows image displays to be performed over a wide range of areas, and enables image displays corresponding to situations of individual persons.

Also, since images are projected onto the front of persons (including both persons who are walking and standing) it is possible to cause the persons to direct great attention to the images. Furthermore, by the speaker having directivity, influences of noises upon surroundings of target persons can also be inhibited.

Having described the embodiment according to the present invention, the present invention is not limited to the above-described embodiment, but the following variations are also possible.

The air-floating image display apparatus, it is not limited to the airship, and it concludes a balloon etc., for example.

(1) In the above-described embodiment, as the airship 1, a type that controls flight by itself was used. Alternatively, however, the airship 1 may be of a type that is controlled from the ground or the like by a radio-control operation or the like. Still alternatively, the airship 1 may be of a type such that, with the image processing section 22 and the projection control section 32 placed on the ground side, signal exchanges between these sections, and the camera and the projector mounted on the airship, are performed via radio waves.

(2) The obstacle detecting sensors 11 may include various kinds of radio wave sensors besides infrared sensors.

(3) In the above-described embodiment, the operational flows of the flight operation of the airship 1 shown in FIG. 3, the obstacle avoidance operation shown in FIG. 4, the operation of the image processing section 22 shown in FIG. 5, and the control operation of the projection control section 32 shown in FIG. 6, are only examples. These may be diversely varied within the scope of the present inventive concepts, which was described with reference to the schematic view in FIG. 1.

(4) The projection by the projector 31 may be performed with respect to either a single target person, or a plurality of target persons.

(5) In the above-described embodiment, the arrangements are constructed by the flight control section 14, the image processing section 22, the projection control section 32, and the sound control section 42, and in addition, the control device 51. Alternatively, however, the arrangements may be such that the entirety of the control sections 14, 22, 32, and 42 incorporates the operations of the control device 51.

1. An air-floating image display apparatus, characterized in that the apparatus comprises:
a flying object capable of moving in the air; and
a projector mounted on the flying object and projecting an image onto the ground below the flying object.

2. The air-floating image display apparatus according to claim 1,
characterized in that the flying object comprises a camera for photographing a place below the flying object; and
that the apparatus projects an image from the projector onto the vicinity of the person recognized based on a photographed image by the camera.

3. The air-floating image display apparatus according to claim 1,
characterized in that the flying object further comprises wings, a wing drive unit for changing the orientation of the wings, a propeller, a propeller drive unit for rotating the propeller, and a plurality of obstacle detecting sensors for detecting an obstacle to the flight of the flying object; and
that the flight of the flying object is controlled by the wings, the wing drive unit, the propeller, the propeller drive unit, and information from the obstacle detecting sensors.

4. The air-floating image display apparatus according to claim 2, characterized in that the projector projects an image onto the front of the recognized person.

5. The air-floating image display apparatus according to claim 2, characterized in that the flying object moves in response to a movement of the recognized person.

6. The air-floating image display apparatus according to claim 2, characterized in that the flying object further comprises a speaker having a directivity by which sound is produced only in the vicinity of the recognized person.

7. The air-floating image display apparatus according to claim 1, characterized in that the focus of the projector is adjusted in accordance with a projection distance of the projector.

8. The air-floating image display apparatus according to claim 1, characterized in that the shape of a projected screen by the projector is corrected so as to have a predetermined aspect ratio, based on the shape of the projected screen by the projector, the shape having being recognized from the photographed image by the camera.
